(19) United States
(12) Patent Application Publication
(10) Pub. No.: US 2005/0279842 A1
(43) Pub. Date: Dec. 22, 2005

(54) Keldosimeter - system and method for automatically maintaining comfortable minimally variable temperatures in structural and vehicular interiors indicating easy cool weather diesel engine starts

(76) Inventor: Adolph Mondry, Plymouth, MI (US)

Correspondence Address: ADOLPH MONDRY, 753 VIRGINIA, PLYMOUTH, MI, 48170, US

(21) Appl. No.: 10/870,647

(22) Filed: Jun. 18, 2004

(51) Int. Cl. F23N 5/20; G05D 23/00

(52) U.S. Cl. 236/46 C; 236/46 R

(57) ABSTRACT

The Keldosimeter is a method and apparatus for automatically maintaining a desired comfortable temperature level in the interior of structures and vehicles and includes delivering a second fan rpm dosage to a duct at a heat exchanger while repeatedly sequencing through the plurality of sequential fan rpm doses beginning with the first fan rpm dose and proceeding to an adjacent dose in the sequence after a predetermined time interval has elapsed. The fan rpm dosage is delivered until the temperature level in the interior attains the desirable range, at which point a corresponding fan rpm dose is selected from the plurality of sequential fan rpm doses. The method also includes delivering the selected fan rpm dose so as to maintain the desired temperature range in the interior of the structure or vehicle.

### CROSS REFERENCES TO RELATED APPLICATIONS

Adolph Mondry—System and method for automatically maintaining a blood oxygen saturation level. U.S. Pat. No. 5,682,877, Nov. 4, 1997—herein referred to as '877. The flow charts of that device are similar to those of the Keldosimeter.

Adolph Mondry—The Voltage Dosimeter—System and method for supplying variable voltage to an electric circuit. P. N. application number not yet available. The flow charts of that device are identical to those of the Keldosimeter.

Adolph Mondry—The Automatic Furnace—System and method for automatically maintaining a multiburner furnace. P. N. application number not yet available. The flow charts of that device are identical to those of the Keldosimeter.

Adolph Mondry—The Stratojet—System and method for automatically maintaining optimum oxygen content in high altitude turbojet engines. P. N. application number not yet available. The flow charts are identical to those of the Keldosimeter.

Jonathan Young et al—Vehicle heater and controls therefor—U.S. Patent Application Number 20040007196—hereafter called '196-1-15-2004—as above.

Paul Douglas Thompson et al—Temperature maintaining apparatus and temperature control apparatus and method therefore. Patent Application Number 20040007628—hereafter called '628-1-15-2004. Demonstrates the heating of diesel engines for cool weather starts, an auxiliary heater for diesel powered vehicles, and the operational states of a liquid heater.

### FEDERALLY SPONSORED RESEARCH GRANTS

There are no Federally sponsored research grants available to those involved in the research and development of this device.

### BACKGROUND OF THIS INVENTION

Most people, particularly when in bed, recognize cyclic discomfort from variably cooled or heated air. The same occurs in manually and automatically thermal controlled vehicle interiors. '196 maintains that a comfortable vehicular interior temperature ensures appropriate engine coolant temperature for sure diesel engine starts in cool temperatures using liquid heaters. It is desirable to have a device with acyclic thermal control.

### BRIEF SUMMARY OF THE INVENTION

It is an object of the present invention to provide a method and apparatus for automatically administering preferably air at a predetermined Temperature (T) from a heat source or sink using the convective air flow of an electric fan as the major part of the heat exchanger to automatically maintain a comfortable minimally variable temperature in structural and vehicular interiors. It is a second object of this invention to indicate by interior vehicular thermal comfort the ease of diesel engine starts in cool weather.

In carrying out the above objects and other stated objects and features of the present invention a method and apparatus is provided as a Keldosimeter for maintaining a desired interior T, which preferably represents the temperature of the ambient air, and includes delivering a first T dose-herein called a Temperature dose, which represents a function of temperature over time or a function of T over the rpm of a fan (here labeled rpm), which propels air through a duct, then into the interior, where a temperature sensor sends data to an ECU, producing a sequential T dose in the interior of the vehicle or structure selected from one of a plurality of sequential T doses between a first T dose and a second T dose. The method includes delivering a second rpm dosage of the electric fan through a heat exchanger to the duct while repeatedly sequencing through the plurality of sequential T doses in the interior of the vehicle or structure beginning with the first T dose and proceeding to an adjacent T dose in the sequence after a predetermined time interval has elapsed. The second rpm dosage is delivered to the duct until the temperature level in the interior of the vehicle or structure attains the desirable range, at which point corresponding rpm doses and T doses are selected from the plurality of rpm doses and the plurality of sequential T doses. The method also includes delivering the selected rpm dose to the duct and T dose to the interior so as to maintain the desired temperature range in the interior.

In the preferred embodiment the method and apparatus employs gaseous air as the main heat exchanger. Liquids and solids may be used as well. Standard heat sources and sinks are preferably employed. Others may be used as well.

The advantages of the Keldosimeter are its ability to maintain desired temperature levels with minimal variation in the interior of structures and vehicles resulting in minimal thermal discomfort, and its ability to indicate easy cold weather starts in diesel engines, when the interior is comfortable.

The above objects, features, and other advantages will be readily appreciated by one of ordinary skill in the art from the following detailed description of the best mode in carrying out the invention, when taken in connection with the accompanying drawings.

### BRIEF DESCRIPTION OF THE DRAWINGS

FIG. 1/6 demonstrates a perspective view of the first embodiment of the present invention.

FIG. 2/6 is a graphical demonstration of the flow charts of the Keldosimeter.

FIG. 3/3-5/6 are flow charts dealing with the rpm dosage and T dosage and level (the latter is labeled T in the flow sheets) strategy of the present invention for use in the Keldosimeter.

FIG. 6/6 is a flow chart for relating parameters in the Keldosimeter.

### DETAILED DESCRIPTION OF THE INVENTION

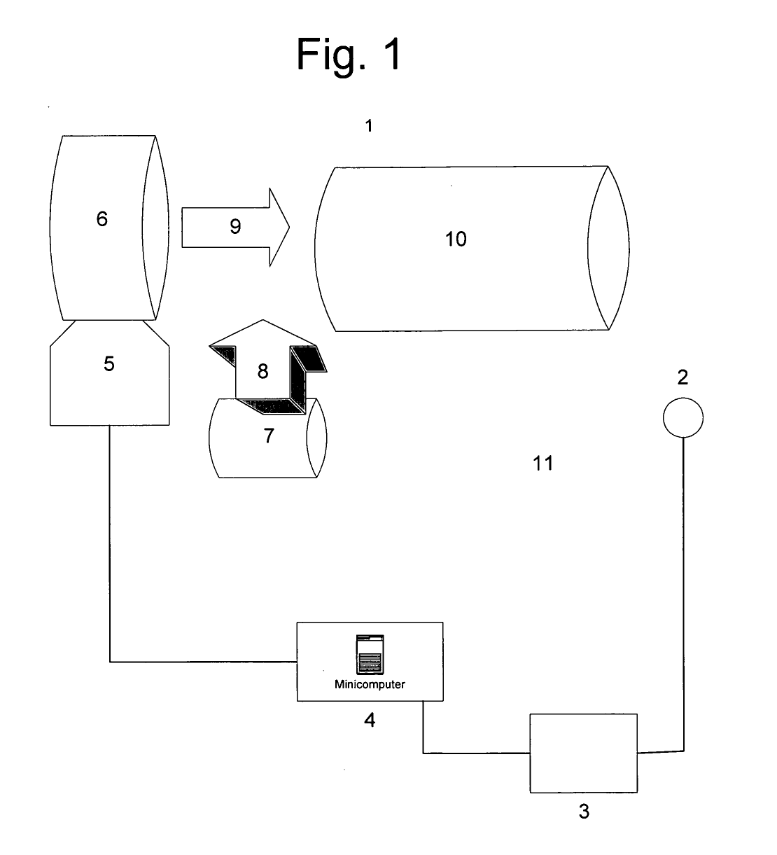

Referring now to FIG. 1/6, a first embodiment of the present invention is shown. This embodiment indicated by reference number 1 in FIG. 1/6 is the best mode in implementing this invention and is particularly suited for use as a Keldosimeter, and includes 2. a temperature sensor, 3. a bandpass filter, 4. the ECU, 5. a variable speed electric motor connected to a fan (6), 7. a heat sink or source, 8. the direction of heat exchange, 9. the direction of air flow, 10. a duct, 11. the interior of a vehicle or structure.

In response to T data 2 in the interior, the fan rpm 6 is controlled by an ECU 4 controlled variable speed electric motor 5, analogous to the variably opening solenoid valve with Coulomb controlling circuits, as was taught in 877 and U.S. Pat. No. 5,008,773. It enhances or restricts heat transfer.

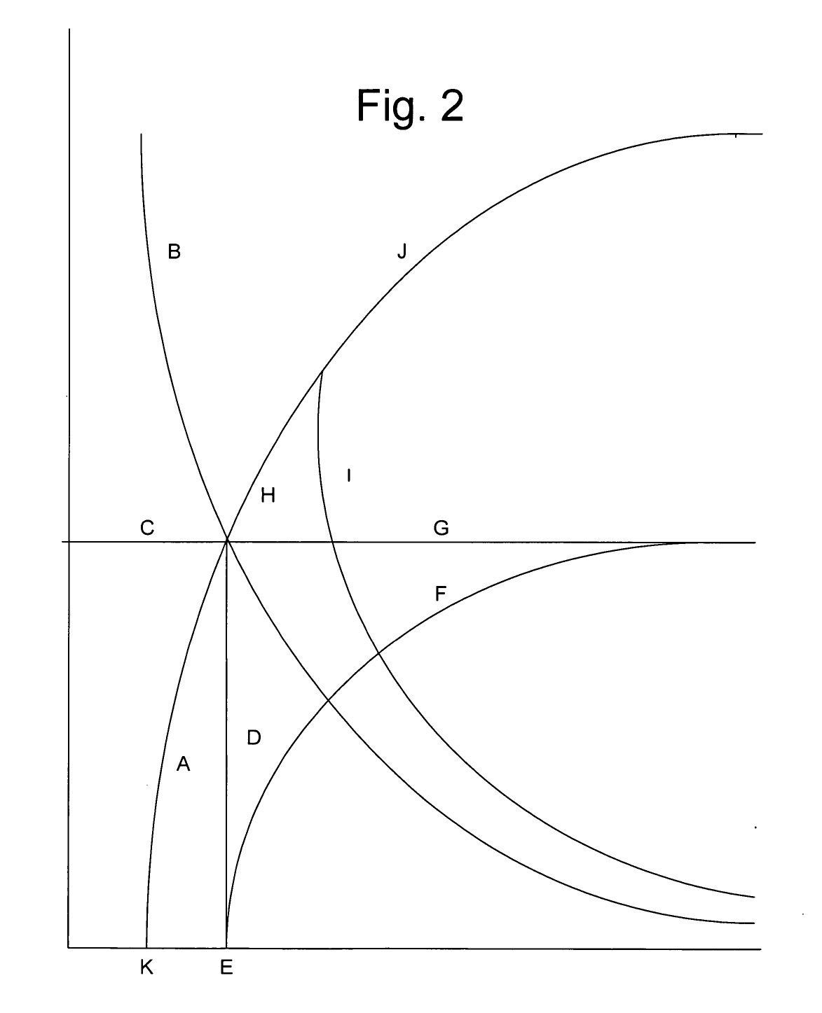

Referring now to FIG. 2/6, the method of device function is demonstrated graphically for heating. For air conditioning the functions are reflected across the abscissa. Temperature is placed on the ordinate and time or fan rpm (doses) are placed on the abscissa of a Cartesian plane. Maximum fan rpm occurs at tr on the abscissa, the significance of which will be presented later. Measured and calculated logarithmic functions are used in the preferred embodiment as T dosages, but any measured and estimated function with an inverse may be used. The lowest logarithmic base implies the highest valued T dosage.

Referring again to FIG. 1/6, as will be seen, conditions on T on the inside of the structure or vehicle control fan rpm dosages and thus the T dosage and T in the interior.

Referring now to FIG. 2/6, the illustrated method of fan rpm dosage and T dosage and level (how both can exist will be explained) selection starts at the duct upstream of the inside of the vehicle or structure with the administration of an extreme fan rpm dosage—herein referred to as the selector dose of the rpm dosage which produces the maximum or minimum T dosage in the interior—as in curve A or B. Curve A is represented by y=log to the base a of x, where a is the smallest base in the system. Curve A activates at x=0.

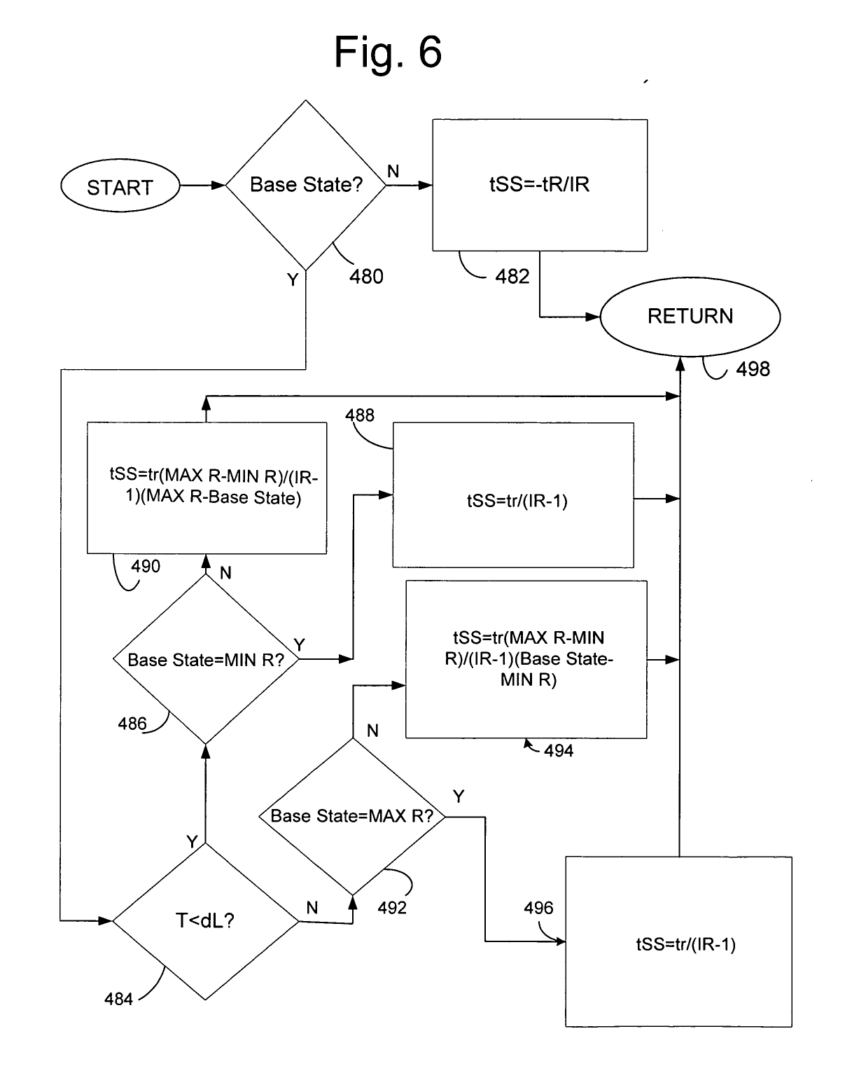

Line CG is the desired T—herein referred to as the selection parameter, which is a range in the actual device. At the intersection of line CG and curve A or B (call it X), line D points to point E on the abscissa as the selected fan rpm (or rpm) dose. This is determined by graphical means and, as will be seen, the flow charts. The virtual T dosage is curve F, which activates at point E, the selected rpm dose, and is boosted by curves A, B, H—an overshoot of curve A—and curve I—a deactivation of curve H—to produce line G, which is the selected T level, and is also a dosage, and is represented by y=log to the base b of tr, where tr is the t value of the flattening out of the logarithm y=log to the base b of t (curve F) at tr seconds, and differs from tr associated with the maximum rpm and T dosage used in FIG. 6/6. This tr is only used for teaching purposes. Base b is greater or equal to base a, which is associated with the maximum rpm and T dosages. Line G is completely determined by the intersection (X) described above and in the flow charts, as will be seen, thus the determination of curve F and line G by the above methods is unnecessary. Curve F and line G start in the x coordinate system at x=t and in the t coordinate system at t=0, when curve A deactivates. Curve F and line G deactivate when curve A activates. Curve J is the virtual curve of curves A and H. K marks the circulation time. It marks the time from the initial maximum rpm to the first recording of any change in the T level. Its accuracy is essential for proper flow chart function with respect to time. Its calculation and that of tr will be demonstrated. The rpm dose is circulation time dependent. The T dose is not, since it is a function of time.

Before describing the flow charts it is useful to explain the terminology employed. The most recent base state keeps the temperature in its desirable range. The temperature and rpm are measured in all states. The washout state washes out overshoots. T doses are functions of rpm doses and time.

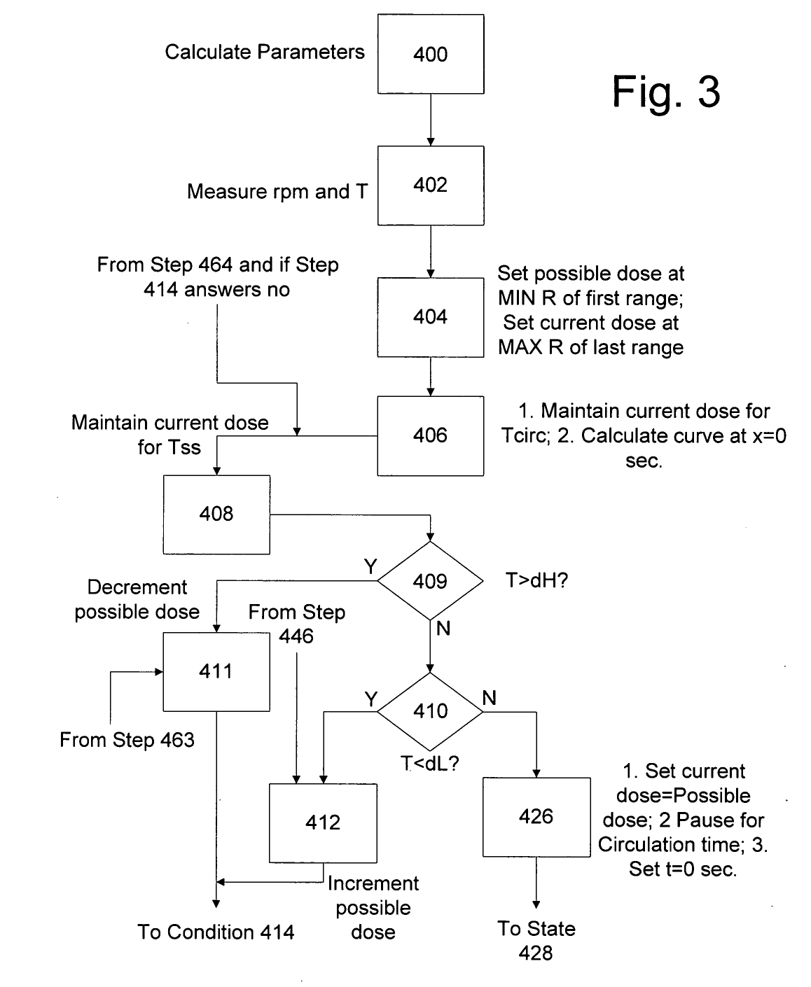

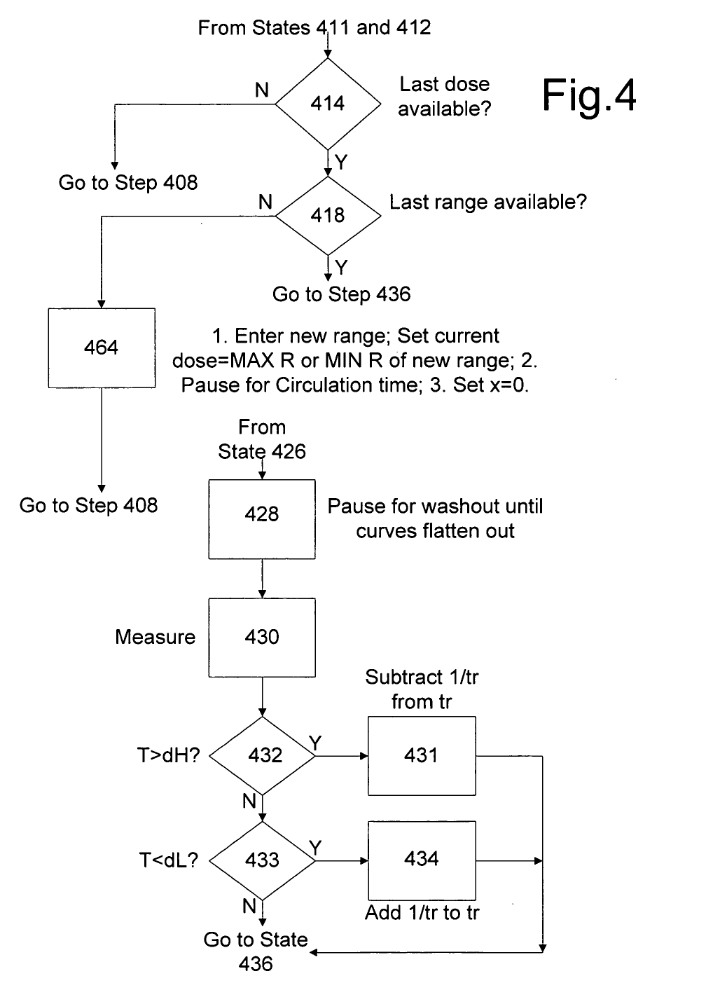

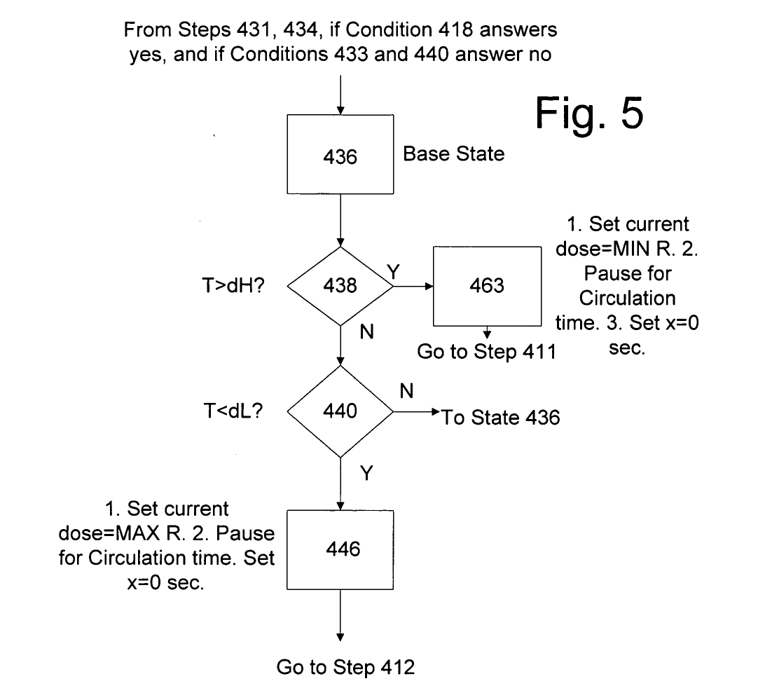

Referring now to FIG. 3/6-5/6, flow charts are shown, which illustrate the system and method for the proper selection of rpm and T doses and levels.

Referring to FIG. 3/6, Step 400 determines various system parameters, which may be predetermined and stored in memory, calculated by an ECU (such as ECU 4 in FIG. 1/6) or entered by a system operator. The system parameters include the following:
MIN R=minimum dose of rpm given for each range.
MAX R=maximum dose of rpm given for each range.
T=temperature
TOl=desired T level.
dL=low T level threshold.
dH=high T level threshold.
Tss=series state delay time.
Tcirc=circulation delay time.
Twash=washout delay time.
tr=desired response time or reaction time—unless otherwise stated it is the largest value of the maximum rpm dosage.
   The value of dH and dL are temperature levels determined by the a trade off between electric motor noise and tight temperature control.

As shown in FIG. 3/6 the ECU now passes control to Step 402, which measures the rpm dose and the T level. At Step 404 a maximum rpm dose of the last range is administered. This is represented graphically by curve A of FIG. 2/6 and is called the selector dose. Curve A represents the graph of the maximum T dose as a function of the maximum rpm dose. Here base a of log to the base a of x is the smallest in the system. The maximum T dose value over the maximum rpm dose is at tr. The maximum rpm value of the maximum rpm dose is tr. The possible T level is set for the lowest level of the lowest range.

With continuing reference to FIG. 3/6 at Step 406 the rpm dose is maintained while pausing Tcirc seconds, then x is set to 0 seconds. Step 406 is called an adjustment state. It coordinates the flow charts with respect to time. Initial circulation times may be estimated or measured.

Referring once again to FIG. 3/6 the ECU passes control to Step 408, which continues to deliver maximum rpm dosage to the duct and maximum T dosage to the interior. Step 408 is referred to as a series state—Tss—and is necessary to coordinate the progression through various possible T levels within a time period determined by tr. The calculation of Tss depends on the current operating state. Some representative calculations are illustrated in FIG. 6/6 for a single ranged implementation as discussed in greater detail below.

Still referring to FIG. 3/6 a test is performed at Steps 409 and 410. It asks—is T greater than dH?—and, is T less than dL?, respectively. They split control into three pathways. Negative answers to both conditions direct control to Step 426, where 1. The possible T level is set to the current level, while the rpm dose is set to its abscissal value. 2. A pause for the circulation time takes place, but here the value of the circulation time is proportionately longer or equal to the previous value. Then, 3. t is set to 0. This represents rpm dose and T level or dose selection.

Now referring to FIG. 4/6 processing continues with the ECU directing control to Step 428, which pauses to washout high valued functions from the selected dose. The state is completed when all involved functions equal a straight line—the selected T level or dose. Both of the above dosages continue until activation of MIN R or MAX R. Figure 430 measures T values for the Conditions below. Steps 409 and 410 represent a second test and ask the same questions as the above mentioned first test—Is T greater than dH or less than dL, respectively? If either answer yes, control is directed to Steps 431 and 434, respectively, where a predetermined fraction of tr is either subtracted or added, respectively to tr. This pathway determines tr only if the circulation time is correct. The circulation time is calculated by keeping the last three base state values in memory. When control is directed to or beyond a noncontiguous base state from which control was originally assumed a predetermined amount of time is added to the circulation time. This will correct abnormally short circulation times. For abnormally long circulation times—if control passes consecutively to two ascending or descending base states, a predetermined amount of time is subtracted from the circulation time.

Referring now to FIG. 5/6, if both conditions in the second test answer no, the ECU places control in Step 436, the base state. Steps 438 and 440 represent the third test and ask the same questions (is T>dH or <dL?) as those of the previous tests with different consequences. They determine the stability of the base state (both conditions answer no if it is stable). If it is unstable, the ECU directs control to either Step 463, if Step 438 answers yes, or 446, which 1. Minimizes or maximizes the current dose, respectively 2. Pauses for the circulation time, then 3. Sets x=0. These doses continue until dose selection. It should be noted that Steps 431, 434, the yes part of 418, and the no part of Steps 433 and 440 all yield control to Step 436, the base state. The ECU then directs control from Step 463 to Step 411, and from Step 446 to Step 412.

Referring again to FIG. 3/6, the ECU directs control from Step 464 (evaluated later), and if Step 414 in FIG. 4/6 (the first condition of fourth test to be elucidated soon) answers no, to Step 408 to maintain the current rpm and T dose for Tss. Control is then directed to Step 409, which, if along with Step 410—the first test—the answer is yes to both conditions, control is passed to Steps 411 and 412, respectively, which decrement and increment the possible dose, respectively, then both pass control to Condition 414.

Referring now to FIG. 4/6, Steps 414 and 418 represent the fourth and final test with different conditions than the other tests. These conditions ask if the present possible dose is the last dose available, and if the present range is the last one available, respectively. If Step 414 answers no, control is directed by the ECU to Step 408 in FIG. 3/6, which maintains a current dose for Tss. If the condition answers yes, control is directed to Step 418, which determines if the present range is the last range available. If it answers no, control is directed to Step 464, in which control enters a new range, sets the current rpm and T dose to MAX R or MIN R of the new range, pauses for the circulation time, then sets x=0. Control is then directed to Step 408, which maintains a current rpm and T dose for Tss. If Step 418 answers yes, the ECU directs control to Step 436, the base state.

Referring now to FIG. 6/6 a flow chart is shown illustrating representative calculations of Tss according to the present invention. One of these calculations or an analogous calculation is performed for each series state of FIG. 3/6-5/6, such as illustrated at Steps 408, 411, and 412.

Returning to FIG. 6/6 at Step 480 a test is performed to determine if the system has reached a base state. If not, the series state delay is estimated as: Tss=tr/IR. If the result is true, the process continues with Step 484, where a test is performed to determine whether T<dL. If true, then Step 486 determines whether the most recent base state is a minimum for the current range. If it is true, the series state delay is calculated by Step 488 as Tss=tr/(IR−1). Step 498 then returns control to the series state which initiated the calculation.

With continuing reference to FIG. 6/6, if the test at Step 486 is false, then the series state delay is calculated by Step 490 as Tss=tr(MAX R−MIN R)/(IR−1)(MAX R−BASE STATE) before control is released to the series state via Step 498. If the test performed at Step 484 is false, then Step 492 performs a test to determine if the most recent base state is the maximum for the current range. If the result of Step 492 is true, then Step 496 calculates the series state delay as Tss=tr/(IR−1). Control is then returned to the appropriate series state via Step 498. If the result of the test at Step 492 is false, then the series state delay is calculated by Step 494 as Tss=tr(MAX R−MIN R)/(IR−1)(BASE STATE−MIN R). Step 498 then returns control to the appropriate series state. FIG. 6/6 applies to a single range. One of ordinary skill in the art should appreciate that the calculations may be modified to accommodate a number of possible ranges.

It should be apparent to any one skilled in the art that the flow charts provide a method and apparatus for a Keldosimeter.

1. A method for maintaining a desired minimally variable temperature level inside a vehicle or structure within a predetermined range of sequential values having an upper limit and a lower limit so as to produce comfort and an indication of easy cool weather diesel engine starts, the method being adapted for use with a Keldosimeter, including an electronic control unit (ECU) having memory, a temperature (T) sensor in a structural or vehicular interior, a heat source or sink, a heat exchanger in close proximity to a variable speed electric fan (rpm) controlled by the ECU for delivering selected rpm doses upstream of a duct, producing T doses in the interior, the T delivery system of the Keldosimeter having a plurality of rpm and T doses ranging from a first dose to a second dose, the method comprising:
delivering the second rpm dose to the duct and the second T dose to the interior, while repeatedly sequencing through the plurality of sequential T doses beginning with the first dose and proceeding to an adjacent dose in the sequence after a predetermined time interval has elapsed until the temperature level in the interior of the structure or vehicle attains the desired level at which point a corresponding rpm dosage and T dosage are selected from the plurality of sequential T and rpm dosages.
delivering the selected T and rpm doses so as to maintain the inside T level in its desired range.

2. The method of claim 1 wherein the current circulation time is determined by:
means for storing a predetermined number of base state values in memory; and
means for determining a predetermined sequence of base state levels.

3. The method of claim 1 wherein the reaction time is determined by logic flow charts.

4. The method of claim 1 wherein solid, liquid, or gas may comprise the heat exchanger, the heat source, or the heat sink.

5. A method for maintaining a desired minimally variable temperature level inside a vehicle or structure within a predetermined range of sequential values having an upper limit and a lower limit so as to produce comfort and an indication of easy cool weather diesel engine starts, the method being adapted for use with a Keldosimeter, including an electronic control unit (ECU) having memory, a temperature (T) sensor in a structural or vehicular interior, a heat source or sink, a heat exchanger in close proximity to a variable speed electric fan (rpm) controlled by the ECU for delivering selected rpm doses upstream of a duct, producing T doses in the interior, the T delivery system of the Keldosimeter having a plurality of rpm and T doses ranging from a first dose to a second dose, the method comprising:
delivering the second rpm dose to the duct and the second T dose to the interior, while repeatedly sequencing through the plurality of sequential rpm doses beginning with the first dose and proceeding to an adjacent dose in the sequence after a predetermined time interval has elapsed until the temperature level in the interior of the structure or vehicle attains the desired level at which point a corresponding rpm dosage is selected from the plurality of sequential rpm dosages.
delivering the selected rpm dosage so as to maintain the temperature inside the structure or vehicle.

6. The method of claim 5 wherein the current circulation time is determined by:
means for storing a predetermined number of base state values in memory; and
means for determining a predetermined sequence of base state levels.

7. The method of claim 5 wherein the reaction time is determined by logic flow charts.

8. The method of claim 5 wherein the solid, liquid or gas may comprise the heat exchanger, the heat source, or sink.
